(19) United States
(12) Patent Application Publication
(10) Pub. No.: US 2016/0124121 A1
(43) Pub. Date: May 5, 2016

(54) OPTICAL MEMBER AND IMAGE PICKUP APPARATUS

(71) Applicant: CANON KABUSHIKI KAISHA, Ohta-ku, Tokyo (JP)

(72) Inventors: Akira Sugiyama, Yokohama-shi (JP); Akiko Takei, Fujisawa-shi (JP); Norishige Kakegawa, Tokyo (JP); Kenji Takashima, Tokyo (JP); Zuyi Zhang, Yokohama-shi (JP); Yoshinori Kotani, Yokohama-shi (JP); Naoyuki Koketsu, Tokyo (JP)

(21) Appl. No.: 14/898,101

(22) PCT Filed: May 23, 2014
(86) PCT No.: PCT/JP2014/064552

§ 371 Date: Dec. 11, 2015

(30) Foreign Application Priority Data
Jun. 28, 2013 (JP) 2013-136159

(51) Int. Cl. G02B 1/118; G02B 1/18

(52) U.S. Cl. CPC G02B 1/118; G02B 1/18

(57) ABSTRACT

There is provided an optical member having a low reflectance and a good dustproof property.

An optical member includes a base and a low-refractive-index layer disposed on the base and containing particles having a refractive index lower than that of the base. A plurality of projections are formed on a surface of the low-refractive-index layer. The width of the projections is 5 nm or more and 80 nm or less and the distance between the projections is 80 nm or more and 250 nm or less.

### TECHNICAL FIELD

The present invention relates to an optical member including a low-refractive-index layer on a base and an image pickup apparatus including the optical member.

### BACKGROUND ART

In image pickup apparatuses such as digital cameras, an image pickup element such as a charge-coupled device (CCD) sensor or a complementary metal oxide semiconductor (CMOS) sensor receives imaging light beams and outputs photoelectrically converted signals. The signals are converted into image data, and the data is stored in a recording medium such as a memory card. In such image pickup apparatuses, an optical filter such as a low-pass filter or an infrared cut filter is disposed on the object side of the image pickup element.

In particular, in lens-replaceable digital cameras, mechanically operating parts such as a shutter are disposed near an optical filter, and foreign matter such as dust generated from the operating parts may adhere to the optical filter. When a lens is replaced, dust and the like present outside the digital camera may enter the main body of the digital camera through an aperture of a lens mount and adhere to the optical filter. If dust adheres to the optical filter, portions to which the dust adheres are taken in an image as black spots, which may degrade the quality of the image.

PTL 1 discloses that a foreign matter adhesion-preventing film composed of a material containing fluorine is formed on the surface of an optical filter in order to suppress the adhesion of dust. PTL 2 discloses that a dustproof film having a fine uneven structure constituted by a petaloid alumina film is formed on a light transmissive member.

### CITATION LIST

### Patent Literature

PTL 1 Japanese Patent Laid-Open No. 2006-163275

PTL 2 Japanese Patent Laid-Open No. 2007-183366

### SUMMARY OF INVENTION

### Technical Problem

The foreign matter adhesion-preventing film described in PTL 1 improves the dustproof property, but increases the reflectance at the surface. The dustproof film described in PTL 2 tends to be degraded in the reflectance and the dustproof property because the dustproof film has low mechanical strength and thus the uneven structure is easily broken.

The present invention provides an optical member having a low reflectance and a good dustproof property and an image pickup apparatus.

### Solution to Problem

An optical member according to an aspect of the present invention includes a base and a low-refractive-index layer disposed on the base and containing particles having a refractive index lower than that of the base. A plurality of projections are formed on a surface of the low-refractive-index layer. The width of the projections is 5 nm or more and 80 nm or less and the distance between the projections is 80 nm or more and 250 nm or less.

### Advantageous Effects of Invention

According to the present invention, there can be provided an optical member having a low reflectance and a good dustproof property and an image pickup apparatus.

### BRIEF DESCRIPTION OF DRAWINGS

FIG. 1 schematically shows an example of an optical member according to an embodiment of the present invention.

FIGS. 2A and 2B are diagrams for describing liquid bridge.

FIG. 3 schematically shows an example of an image pickup apparatus including the optical member according to an embodiment of the present invention.

FIG. 4 is an electron micrograph in a cross section of an optical member 1 produced in Example 1.

FIG. 5 shows a surface profile of the optical member 1 produced in Example 1.

### DESCRIPTION OF EMBODIMENTS

The present invention will now be described in detail on the basis of embodiments of the present invention. Well-known or publicly known techniques in the technical field concerned are applied to components that are not particularly illustrated or described in this specification.

### Optical Member

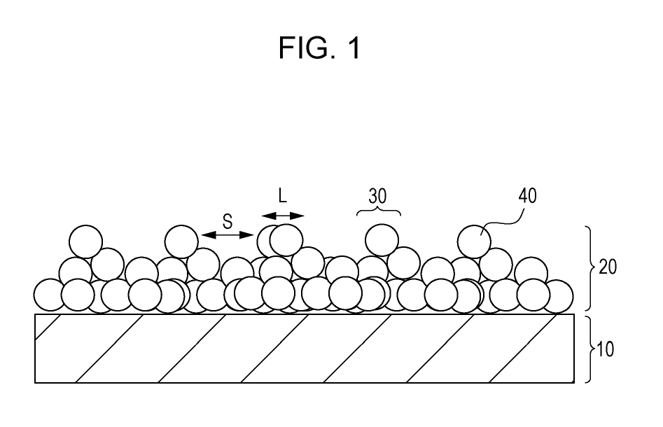

As shown in FIG. 1, an optical member according to an embodiment of the present invention includes a base 10 and a low-refractive-index layer 20 that is disposed on the base 10 and contains particles 40 having a refractive index lower than that of the base 10. A plurality of projections 30 are formed on a surface of the low-refractive-index layer 20. The width L of the projections 30 is 5 nm or more and 80 nm or less and the distance S between the plurality of projections 30 is 80 nm or more and 250 nm or less.

Since the low-refractive-index layer 20 has a refractive index lower than that of the base 10, the reflection at the surface (the interface between the low-refractive-index layer 20 and the air) of the optical member is suppressed compared with a structure including no low-refractive-index layer 20. Thus, the reflectance is reduced.

Furthermore, since the width (size of the tips of the projections 30) L of the projections 30 on the surface of the low-refractive-index layer 20 is 5 nm or more and 80 nm or less and the distance S between the projections 30 is 80 nm or more and 250 nm or less, an adhesive force exerted on dust is low and a good dustproof property can be achieved.

The inventors of the present invention assume the mechanism of improving the dustproof property to be as follows. In general, when no irregularities are formed on the surface, a force (adhesive force) that attracts dust is generated on the entire surface. On the other hand, in the low-refractive-index layer 20 according to an embodiment of the present invention, such an adhesive force is generated only on the projections 30 of the low-refractive-index layer 20.

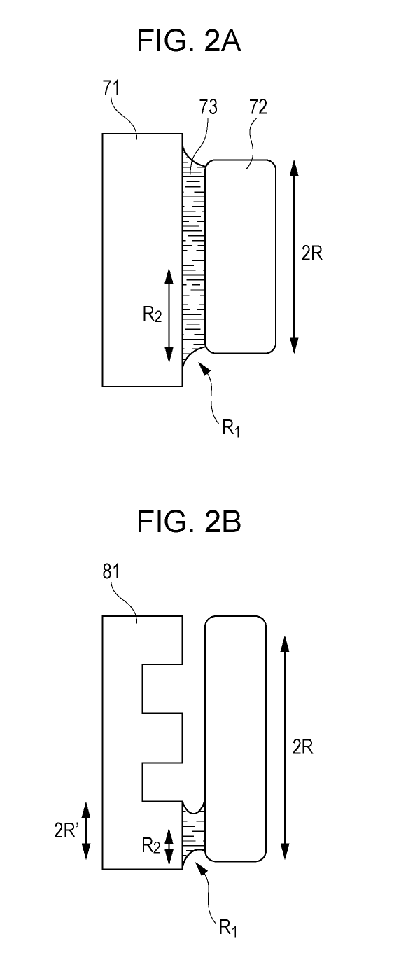

FIGS. 2A and 2B schematically show the adhesive force generated by liquid bridge. If a liquid 73 is present between an object 71 (or 81) and a dust 72, liquid bridge is formed between the object 71 (or 81) and the dust 72. The pressure is different between the inside (liquid side) and the outside (air side) of the air interface of the liquid bridge, and the pressure on the liquid side is lower than that on the air side. The pressure on the air side is equivalent to the atmospheric pressure and the pressure on the liquid side is a negative pressure, which is lower than the atmospheric pressure. The negative pressure P is represented by formula 1. The adhesive force F is a value obtained by multiplying the negative pressure P by the contact area S with the dust 72, which is represented by formula 2. Herein, R₁ represents a radius of curvature of the air interface of the liquid 73 formed between the object 71 (or 81) and the dust 72. R₂ represents a radius of a contact region between the object 71 (or 81) and the liquid 73. The contact area S is represented by a product of a surface area S₀ of the object 71 (or 81) and a ratio β of the projections on the surface. Furthermore, σ is a constant.

P=σ(1/R₁−1/R₂) Formula 1

F=PS=PS₀β Formula 2

FIG. 2A shows the case where the surface of the object 71 is a smooth surface. In FIG. 2A, R₂ corresponds to a radius R of the dust 72. FIG. 2B shows the case where the object 81 has a plurality of projections on its surface. In FIG. 2B, R₂ corresponds to a half width R′ of a projection. The projection corresponds to each of the projections 30 in FIG. 1.

As is clear from the formula 1, the adhesive force is decreased by bringing R₂ close to R₁, that is, by decreasing the contact area between the object 71 (or 81) and the liquid 73.

Therefore, the width L of the projections 30 of the low-refractive-index layer 20 may be decreased. However, if the width L of the projections 30 is smaller than 5 nm, the mechanical strength of the optical member decreases and the projections 30 are easily broken, which makes it difficult to maintain a low reflectance and a good dustproof property. If the width L of the projections 30 is larger than 80 nm, the contact area between the projections 30 and the dust increases, which makes it difficult to achieve an effect of reducing an adhesive force by liquid bridge. Therefore, the width L of the projections 30 can be 5 nm or more and 80 nm or less.

As shown by the formula 2, the adhesive force can also be decreased by decreasing the ratio β of the projections 30 on the surface. A small ratio β can be achieved not only by decreasing the width L of the projections 30 but also by increasing the distance S between the projections 30. From this point of view, the distance S between the projections 30 can be 80 nm or more. Herein, if the distance S between the projections 30 is more than 250 nm, droplets enter the spaces between the projections 30 and the liquid is not divided between the projections 30. Consequently, an effect of scattering liquid bridge by the projections 30 is not easily achieved. Therefore, the distance S between the projections 30 can be 80 nm or more and 250 nm or less.

The optical member according to an embodiment of the present invention has the plurality of projections 30, but can be used as an optical member without posing any problem because the degree of scattering caused by the projections 30 is low. In particular, the optical member can be used for light that travels in straight lines without posing any problem at all.

The width L of the projections 30 and the distance S between the projections 30 can be measured by the following method. First, the surface profile of the optical member is measured with an atomic force microscope (hereafter abbreviated as “AFM”) (E-Sweep manufactured by Seiko Instruments Inc.). A cross-sectional image in a scanning direction (horizontal direction) of the AFM is obtained from the measurement data of the surface profile. In the obtained image, projections having a height of 5 nm or more are defined as the projections 30. The reason why projections having a height of 5 nm or more are defined as the projections 30 is that, if the height of the projections 30 is less than 5 nm, an effect of scattering liquid bridge is not achieved and thus a good dustproof property is not achieved. At least 20 widths of the projections 30 at a position 5 nm from the peaks of the projections 30 are measured in the cross-sectional image. The average of the measured widths is defined as the width L of the projections 30. Furthermore, at least 20 distances between the peaks of the projections 30 are measured. The average of the measured distances is defined as the distance S.

The ratio L/S of the width of the projections 30 to the distance between the projections 30 is preferably less than 1.00 and more preferably less than 0.60. When the ratio L/S is less than 1.00, the contact area between the surface of the optical member and an adherent can be sufficiently reduced.

The difference in refractive index between the low-refractive-index layer 20 and the base 10 is preferably 0.10 or more and more preferably 0.20 or more. When the difference in refractive index is in the above range, the reflection at the surface can be more efficiently suppressed.

The thickness of the low-refractive-index layer 20 is preferably 50 nm or more and 400 nm or less and more preferably 200 nm or less. If the thickness is less than 50 nm, it is difficult to form projections 30 having a size that contributes to a dustproof property and thus a good dustproof property is not achieved. If the thickness is more than 400 nm, scattering considerably occurs.

The thickness of the low-refractive-index layer 20 can be measured by the following method. First, a SEM image (electron micrograph) is taken with a scanning electron microscope (FE-SEMS-4800, manufactured by Hitachi, Ltd.) at an accelerating voltage of 5.0 kV. The thickness of the low-refractive-index layer 20 on the base is measured at 20 or more points on the image. The average of the thicknesses is used as the thickness of the low-refractive-index layer 20.

The particles 40 contained in the low-refractive-index layer 20 may be any particles as long as they have a refractive index lower than that of the base 10. The difference in refractive index between the particles 40 and the base 10 is preferably 0.10 or more and more preferably 0.20 or more. The low-refractive-index layer 20 containing the particles 40 in the above range can more efficiently suppress the reflection at the surface.

Examples of a material suitably used for the particles 40 include silicon oxide, aluminum oxide, titanium oxide, zirconium oxide, zinc oxide, cerium oxide, and yttrium oxide. The particles 40 may be particles obtained by combining two or more of the above oxides. Furthermore, the particles 40 may be composed of polystyrene, silicone, nylon, polypropylene, polyethylene terephthalate, styrene acrylic resin, polyimide, and polylactic acid.

To achieve a lower refractive index, the particles 40 can be suitably hollow particles that are composed of the above material or particles that are composed of the above material and each have pores on the surface thereof. Specifically, particles having a structure including pores with a size of 1 nm or more and 10 nm or less or particles (hollow particles) having a hollow structure may be used. In particular, hollow particles can be employed in terms of environmental stability.

By modifying the surface, particles 40 each having a surface whose chemical state is changed can also be used. Specifically, surfaces of inorganic oxide particles may be subjected to organic modification with a silane coupling agent or the like.

The particle diameter of the particles 40 can be 10 nm or more and 100 nm or less. If the particle diameter is less than 10 nm, it tends to be difficult to form the projections 30 on the surface of the optical member. If the particle diameter is more than 100 nm, the size of the projections 30 (the width L of the projections 30) increases and thus it tends to be difficult to achieve a low adhesive force at contact points with dust.

The low-refractive-index layer 20 may contain a binder for bonding the plurality of particles 40, which is desirable because the strength of the low-refractive-index layer 20 tends to be increased by the binder.

Any binder may be used as long as the refractive index of the low-refractive-index layer 20 is lower than that of the base 10. Specifically, the binder may be composed of a monomer, a dimer, an organic polymer of at least a trimer, or an inorganic polymer prepared by a sol-gel process. Examples of the organic polymer include acrylic acid esters, methacrylic acid esters and derivatives thereof, and epoxy resins.

The binder may also be composed of an inorganic material prepared by a sol-gel process. A specific example of the inorganic material is silicon oxide. Other examples of the inorganic material include materials obtained by combining a high-refractive-index material such as aluminum oxide, titanium oxide, or zirconium oxide with a low-refractive-index material such as silicon oxide or magnesium fluoride.

A polymer having a low degree of polymerization can be suitably used as a binder that provides ease of filling and ease of control of a filling factor. In addition to the binder, a solvent for adjusting viscosity and surface tension may be added. To increase the adhesiveness between the particles 40, a silane coupling agent may be added. The low-refractive-index layer 20 may contain at least one material for adjusting the refractive index, in addition to the particles 40. To provide the multiple functions described above, various materials may be combined with each other.

When the particles are assumed to have a weight-percent concentration Cp and the binder is assumed to have a weight-percent concentration Cb, the component ratio Cp/Cb can be more than 3.0. When the component ratio Cp/Cb is more than 3.0, the ratio of the binder to the particles is small. Therefore, the projections 30 are easily formed on the surface of the low-refractive-index layer 20 due to their particle shape, which tends to provide a good dustproof property.

In the present invention, each of the projections 30 can be constituted by a plurality of particles 40. The presence of a plurality of particles 40 at one contact point produces combined effects of suppressing liquid bridge by the projections 30 and suppressing liquid bridge by reducing the contact area as a result of decreasing the number of contact points at the projections 30. Consequently, the optical member according to an embodiment of the present invention can exhibit a good dustproof property.

The base 10 and the low-refractive-index layer 20 are not necessarily in contact with each other, and an intermediate layer may be formed between the base 10 and the low-refractive-index layer 20. The intermediate layer desirably has a refractive index between refractive indices of the base 10 and the low-refractive-index layer 20. The presence of the intermediate layer tends to realize a low reflectance at the surface of the optical member. The intermediate layer may have a monolayer structure or a multi-layer structure in which the refractive index decreases in a direction from the base 10 toward the low-refractive-index layer 20.

The base 10 can be composed of any material suitable for the purpose. The base 10 can be composed of, for example, quartz glass, rock crystal, or infrared cut glass in terms of transparency, heat resistance, and strength. The base 10 may have a layered structure composed of different materials.

The base 10 can be transparent. The transmittance of the base 10 is preferably 50% or more and more preferably 60% or more in a visible region (wavelength range of 450 nm or more and 650 nm or less). If the transmittance is less than 50%, some problems may be posed when the base 10 is used for an optical member. The haze of the base 10 can be 0.10% or less. The base 10 may also be composed of a material for low-pass filters, infrared cut filters, and lenses.

The optical member according to an embodiment of the present invention may be optical members used in various displays for television sets and computers, polarizing plates for liquid crystal displays, viewing lenses for cameras, prisms, fly-eye lenses, and toric lenses and may also be various lenses used in image-taking optical systems using these optical members, optical systems for observation, such as binoculars, projection optical systems for liquid crystal projectors, and scanning optical systems for laser-beam printers.

The optical member according to an embodiment of the present invention may be used in image pickup apparatuses such as digital cameras and digital video cameras. In particular, the optical member according to an embodiment of the present invention can be effectively used in image pickup apparatuses, for example, as a low-pass filter. In optical filters such as low-pass filters, it is important to impart a dustproof property to one filter located at the outermost surface. Therefore, a plurality of filters are not used and the margin of scattering required for each optical member is large. Furthermore, since many of such optical filters have a shape without a radius of curvature, scattering due to oblique incidence hardly becomes problematic. Therefore, even if projections 30 having a size that can provide a good dustproof property are formed, scattering causes no problems. Thus, an image pickup apparatus including the optical member according to an embodiment of the present invention has a good dustproof property while hardly causing scattering.

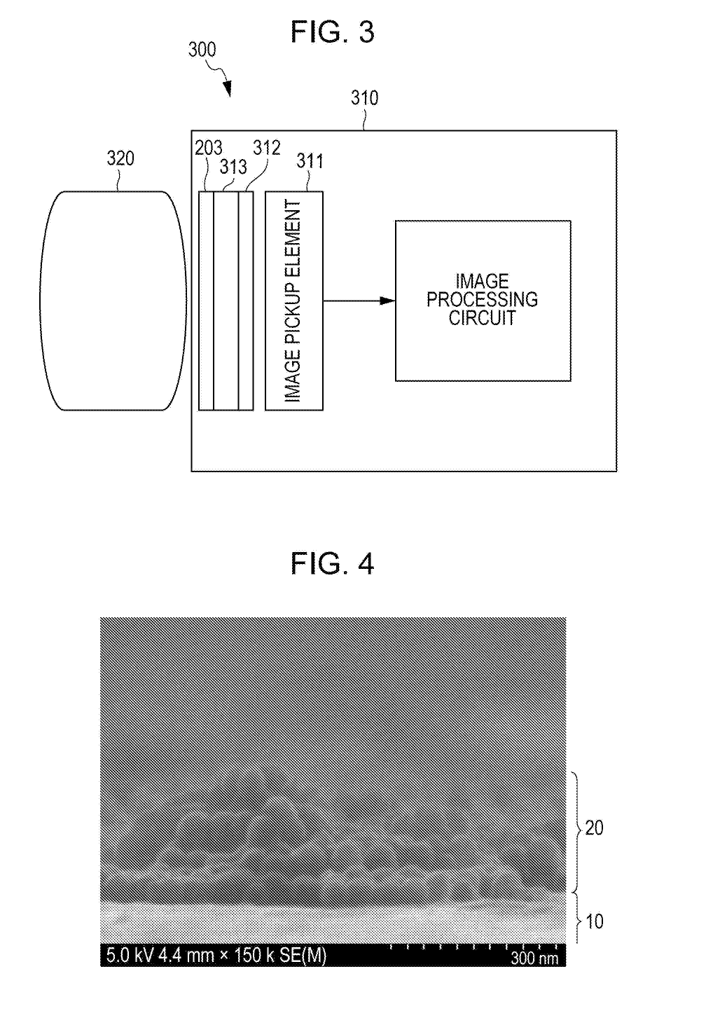

FIG. 3 is a schematic sectional view showing a camera (image pickup apparatus) including the optical member according to an embodiment of the present invention, more specifically, an image pickup apparatus configured to form an object image on an image pickup element through a lens and an optical filter.

An image pickup apparatus 300 includes a main body 310 and a detachable lens 320. An image pickup apparatus, such as a digital single-lens reflex camera, can take images at various view angles by replacing an image-taking lens to other image-taking lenses having different focal lengths. The main body 310 includes an image pickup element 311, an infrared cut filter 312, a low-pass filter 313, and an optical member 203 according to an embodiment of the present invention. The optical member 203 includes the base 10 and the low-refractive-index layer 20 as shown in FIG. 1.

The optical member 203 and the low-pass filter 313 may be integrally disposed or separately disposed. The optical member 203 may also serve as a low-pass filter. That is, the base 10 of the optical member 203 may be a low-pass filter.

The image pickup element 311 is accommodated in a package (not shown) while being hermetically sealed with a cover glass (not shown). The space between the optical filters, such as the low-pass filter 313 and the infrared cut filter 312, and the cover glass is hermetically sealed with a sealing member such as a double-sided tape (not shown). Although the case where the optical filter includes both the low-pass filter 313 and the infrared cut filter 312 is described, the optical filter may be one of the low-pass filter 313 and the infrared cut filter 312.

Since the optical member 203 according to an embodiment of the present invention has an uneven structure near its surface, the optical member 203 is highly dustproof, for example, it is capable of preventing dust adhesion.

Thus, the optical member 203 is disposed on the optical filter so as to be located on the side opposite to the image pickup element 311. The optical member 203 is disposed so that the low-refractive-index layer 20 is farther from the image pickup element 311 than the base 10. In other words, the optical member 203 can be disposed so that the base 10 and the low-refractive-index layer 20 are located in that order from the image pickup element 311 side. The optical member 203 and the image pickup element 311 are disposed so that an image that has passed through the optical member 203 can be taken by the image pickup element 311.

The image pickup apparatus 300 according to an embodiment of the present invention may include a dust-removing device (not shown) for removing dust by generating vibration or the like. The dust-removing device includes, for example, a vibrating member and a piezoelectric element.

The dust-removing device may be disposed at any position between the image pickup element 311 and the optical member 203. For example, the vibrating member may be disposed so as to be in contact with the optical member 203, the low-pass filter 313, or the infrared cut filter 312. In particular, when the vibrating member is disposed so as to be in contact with the optical member 203, dust can be more efficiently removed because dust does not easily adhere to the optical member 203 according to an embodiment of the present invention.

The vibrating member of the dust-removing device may be provided integrally with an optical filter such as the optical member 203, the low-pass filter 313, or the infrared cut filter 312. The vibrating member may be constituted by the optical member 203 or may have a function of the low-pass filter 313, the infrared cut filter 312, or the like.

### Method for Producing Optical Member

The optical member according to an embodiment of the present invention may be produced by any method as long as the optical member that satisfies the scope of the present invention can be produced. The production method according to an embodiment of the present invention will be described below based on an example in which silicon oxide particles (silica particles) are used as the particles 40 of the low-refractive-index layer 20. However, the production method according to an embodiment of the present invention is not limited thereto.

In the present invention, a low-refractive-index layer 20 containing silica particles is suitably formed on the base 10 by, for example, spin coating, dip coating, spraying, or capillary coating.

A method for producing the optical member according to an embodiment of the present invention will now be described in detail based on an example that uses spin coating.

A coating solution for forming a low-refractive-index layer 20 is prepared. A particle-dispersed solution prepared by dispersing, in a solvent, silica particles having a lower refractive index than the base 10 can be used as the coating solution. The viscosity and concentration of the coating solution can be suitably adjusted in accordance with the optical member.

The weight-percent concentration Cp of the silica particles is preferably 4.0 wt % or more and more preferably 5.0 wt % or more. When the weight-percent concentration Cp is within the above range, the aggregation of the silica particles appropriately proceeds during drying. Consequently, the projections 30 that exhibit a good dustproof property tend to be formed on the surface of the low-refractive-index layer 20.

In order to maintain a certain level of dispersion of the silica particles, a solvent having a high affinity for silica particles can be suitably used as the solvent used to disperse the silica particles. If the affinity is low, the silica particles sometimes aggregate and precipitate. Specific examples of the solvent include water solvents, organic solvents, and mixed solvents containing water solvents and organic solvents. Pure water or the like can be used as the water solvent. Examples of the organic solvents include alcohols such as methanol and ethanol; ketones such as methyl ethyl ketone, acetone, and acetylacetone; and hydrocarbons such as hexane and cyclohexane.

The boiling point of the solvent is preferably 100° C. or higher and more preferably 130° C. or higher to form ideal projections 30. Specifically, 2-ethoxyethanol (ethyl cellosolve) or the like can be suitably used. The solvent having a boiling point in the above range is evaporated at an appropriate rate during drying. Consequently, the aggregation of the silica particles proceeds and projections 30 having a good dustproof property tend to be formed.

To control the dispersibility of the silica particles, an additive may be suitably added to the coating solution.

The coating conditions for the coating solution are not particularly limited as long as the optical member within the scope of the present invention can be produced, and can be changed in accordance with the purpose.

The spin coating conditions do not limit the present invention. However, the rotational speed in spin coating is desirably not suddenly increased to the rotational speed at which film formation is achieved, and the rotation can be performed for a certain period of time at a rotational speed lower than the rotational speed at which film formation is achieved. Specifically, the rotation may be performed for a certain period of time at a constant low rotational speed or the rotational speed is gradually increased to lengthen the time for which the rotation is performed at a low rotational speed. In the latter case, specifically, the rate of increase in the rotational speed can be 2000 rpm/s or less. Note that the low rotational speed is in the range of 100 rpm or more and 3000 rpm or less. The time for which the rotation is performed at a low rotational speed can be 1 second or longer.

In the case where the rotation at a low rotational speed is not performed, the solvent is uniformly evaporated during film formation, and thus it tends to be difficult to form the projections 30 on the surface of the low-refractive-index layer 20. In particular, in the case where a coating solution containing two or more types of solvents having different boiling points is used and the rate of increase in the rotational speed is 2000 rpm/s or less, the viscosity of the coating solution is believed to change stepwise depending on the boiling points of the solvents when the rotational speed is increased. Consequently, the projections 30 tend to be formed on the surface of the low-refractive-index layer 20.

The temperature at which the coating solution is applied by spin coating can be suitably changed in accordance with desired projections 30 of the optical member. Specifically, the temperature can be in the range of 10° C. or higher and 40° C. or lower in terms of ease of control.

To increase the physical strength of the optical member, a certain amount of heat is applied to melt the surfaces of the silica particles, whereby silica particles adjacent to each other may be bonded to each other. Alternatively, to increase the physical strength of the optical member, a binder-containing solution containing a binder for bonding particles may be applied before or after the application of the particle-dispersed solution.

The viscosity, concentration, and the like of the binder-containing solution can be suitably adjusted in accordance with the optical member. The weight-percent concentration Cb of the binder is preferably 2.0 wt % or less and more preferably 1.0 wt % or less. When the weight-percent concentration Cb is within the above range, fine projections 30 based on the particle shape tend to be formed after drying and thus projections 30 that exhibit a good dustproof property are easily formed.

To facilitate the dispersion/dissolution of the binder, a solvent having a high affinity for the binder can be suitably used as the solvent for dispersing the binder. If the affinity is low, the binder sometimes aggregate and precipitate. The solvent can be suitably selected in accordance with the binder. Specific examples of the solvent include water solvents, organic solvents, and mixed solvents containing water solvents and organic solvents. To control the dispersion and solubility of the binder, an additive may be suitably added to the binder-containing solution.

The temperature at which the binder-containing solution is applied is not particularly limited, but may be generally 10° C. or higher and 40° C. or lower in terms of ease of control of film formation.

The particle-dispersed solution and the binder-containing solution may be separately applied or a mixture of the particle-dispersed solution and the binder-containing solution may be applied. After the application of the particle-dispersed solution and the binder-containing solution, a drying process may be performed to control the volatilization of solvent components.

To increase the strength of the low-refractive-index layer 20, a heat treatment process can be performed after the film formation of the coating solution. The heat treatment temperature can be a temperature at which the binder does not decompose. When the particles 40 are particles having pores, the heat treatment needs to be performed under the conditions that the pores do not disappear due to the heat treatment and thus the refractive index does not considerably increase. For example, in the case of an inorganic material prepared by a sol-gel process, a heat treatment is performed at a temperature of 50° C. or higher and 700° C. or lower, whereby the polycondensation of the inorganic material can be caused to proceed to increase the strength. The heat treatment time can be suitably set in accordance with the material.

A publicly known heat treatment method can be used. The heat treatment method may involve the use of an electric furnace, an oven, or infrared radiation. Any heating methods such as convective, radiant, and electric heating methods can be employed.

In addition to the members and structures described above, the optical member according to an embodiment of the present invention may further include layers for imparting various functions. For example, in order to impart water repellency, a water-repellent film composed of a fluoroalkylsilane, an alkylsilane, or the like can be disposed on the surface of the low-refractive-index layer 20 so as to follow the shape of the projections 30. In order to improve the adhesiveness to the base 10, an adhesive layer or a primer layer may be disposed between the low-refractive-index layer 20 and the base 10.

### EXAMPLES

Examples will be described below, but the present invention is not limited to Examples.

### Preparation of Binder Solution 1

After 3.3 g of ethyl silicate (special grade, manufactured by KISHIDA CHEMICAL Co., Ltd.) and 1.5 g of ethyl cellosolve (special grade, manufactured by KISHIDA CHEMICAL Co., Ltd.) were mixed, the resulting mixture was stirred at normal temperature for 4 hours to prepare a solution A. After 4.3 g of a 0.01 mol/L aqueous hydrochloric acid solution (manufactured by KISHIDA CHEMICAL Co., Ltd.) and 0.9 g of ethyl cellosolve (special grade, manufactured by KISHIDA CHEMICAL Co., Ltd.) were mixed, the resulting mixture was stirred at normal temperature for 4 hours to prepare a solution B. The solution B was added to the solution A, and stirring was performed for 1 hour to prepare a solution C. The solid content of the solution C when all the silicon components contained in the solution C are assumed to be converted into silica was 9.6 wt %.

An appropriate amount of ethyl cellosolve was added to the solution C to prepare a binder solution 1 having a solid content of 2.4 wt %.

### Preparation of Binder Solution 2

A binder solution 2 was prepared by the same method as in the binder solution 1, except that an appropriate amount of ethyl cellosolve was added to the solution C so that the solid content of the binder solution 2 was 4.8 wt %.

### Preparation of Binder Solution 3

A binder solution 3 was prepared by the same method as in the binder solution 1, except that an appropriate amount of ethyl cellosolve was added to the solution C so that the solid content of the binder solution 3 was 7.2 wt %.

### Preparation of Binder Solution 4

A perhydropolysilazane (hereafter abbreviated as “PHPS”) dibutyl ether solution (trade name: Aquamica NN-320-20, manufactured by AZ Electronic Materials) was diluted with a dibutyl ether solvent at a dilution factor of 15 to prepare a binder solution 4.

### Preparation of Particle-Dispersed Solution 1

A hollow silica particle-dispersed solution (trade name: Sluria 1110, manufactured by JGC Catalysts and Chemicals Ltd.) having an average particle diameter of 50 nm was diluted with an ethyl cellosolve (special grade, manufactured by KISHIDA CHEMICAL Co., Ltd.) solvent so that the particle solid content was 10.0 wt %. Thus, a particle-dispersed solution 1 was prepared.

### Preparation of Particle-Dispersed Solution 2

A particle-dispersed solution 2 was prepared in the same manner as in the particle-dispersed solution 1, except that dilution was performed so that the particle solid content was 8.0 wt %.

### Preparation of Particle-Dispersed Solution 3

A particle-dispersed solution 3 was prepared in the same manner as in the particle-dispersed solution 1, except that dilution was performed so that the particle solid content was 4.0 wt %.

### Preparation of Particle-Dispersed Solution 4

A particle-dispersed solution 4 was prepared by mixing 50 wt % of a 2-propanol (hereafter abbreviated as “IPA”) dispersion solution containing silica particles having an average particle diameter of 200 nm (trade name: Quartron PL-20-IPA, manufactured by FUSO CHEMICAL CO., LTD.) and 50 wt % of IPA. The silica particles are not hollow particles.

### Preparation of Coating Solution 1

The binder solution 1 and the particle-dispersed solution 1 were mixed at a weight ratio of 1:1 to prepare a coating solution 1 in which the solid content of the binder component was 1.2% and the particle solid content was 5.0%.

### Preparation of Coating Solutions 2 to 4

Coating solutions 2 to 4 were prepared in the same manner as in the coating solution 1, except that the binder solutions and particle-dispersed solutions listed in Table 1 were used.

TABLE 1

| | Coating | Coating | Coating | Coating |
|---|---|---|---|---|
| | solution 1 | solution 2 | solution 3 | solution 4 |
| Type of binder | Binder | Binder | Binder | Binder |
| solution | solution 1 | solution 1 | solution 2 | solution 3 |
| Type of particle- | Particle- | Particle- | Particle- | Particle- |
| dispersed solution | dispersed | dispersed | dispersed | dispersed |
| | solution 1 | solution 2 | solution 1 | solution 1 |

### Example 1

The coating solution 1 was applied dropwise to a quartz base (refractive index: 1.54). The rotational speed of the quartz base was increased to 4000 rpm in three seconds, spin coating was performed for 30 seconds, and the rotational speed was decreased to 0 rpm in three seconds.

Subsequently, the coating solution 1 was dried using a hot plate at 150° C. for 10 minutes and then heat-treated at 300° C. for 1 hour to convert the binder component into silica. Thus, an optical member 1 was produced.

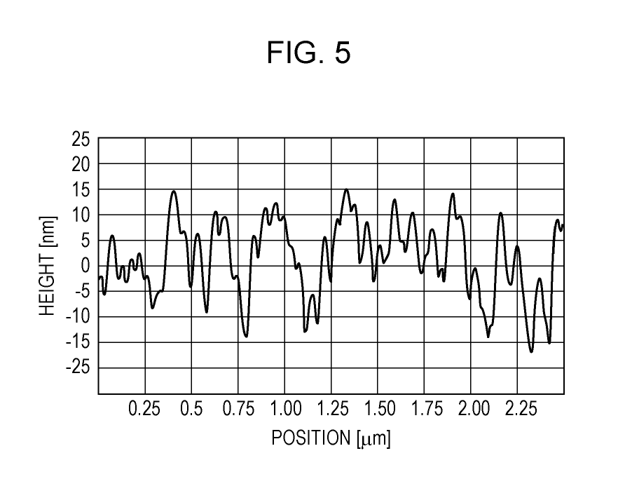

FIG. 4 shows a surface profile of the optical member 1 through SEM observation. FIG. 5 shows a surface profile of the optical member 1 through AFM observation. A low-refractive-index layer containing silica particles was formed.

Projections were formed on the surface of the optical member 1. The width L of the projections was 38 nm and the distance S between the projections was 101 nm.

### Examples 2 and 3

Optical members 2 and 3 were produced in the same manner as in the optical member 1, except that the coating solutions listed in Table 2 were used.

### Comparative Example 1

An optical member 4 was produced in the same manner as in the optical member 1, except that the coating solution listed in Table 2 was used.

### Comparative Example 2

The particle-dispersed solution 3 was applied dropwise to a quartz base (refractive index: 1.54). The rotational speed of the quartz base was increased to 4000 rpm in three seconds, spin coating was performed for 30 seconds, and the rotational speed was decreased to 0 rpm in three seconds. The particle-dispersed solution 3 was dried using a hot plate at 150° C. for 10 minutes.

The binder solution 1 was then applied dropwise to the sample. The rotational speed was increased to 4000 rpm in three seconds, spin coating was performed for 30 seconds, and the rotational speed was decreased to 0 rpm in three seconds.

The binder solution 1 was dried using a hot plate at 150° C. for 10 minutes and then heat-treated at 300° C. for 1 hour to convert the binder component into silica. Thus, an optical member 5 was produced.

### Comparative Example 3

The particle-dispersed solution 4 was applied dropwise to a base. Spin coating was performed at 5000 rpm for 20 seconds. The particle-dispersed solution 4 was then dried using a hot plate at 150° C. for 20 minutes to obtain a large-particle monolayer.

The binder solution 4 was applied dropwise to the large-particle monolayer and spin coating was performed at 3000 rpm for 20 seconds.

Subsequently, the sample was irradiated with ultraviolet rays for 10 minutes using an ultraviolet lamp to convert the PHPS into silica. The application of the PHPS and the silica conversion were repeatedly performed three times to produce an optical member 6.

Table 3 shows the properties of the projections of the optical members in Examples 1 to 3 and Comparative Examples 1 to 3.

TABLE 2

| | | | | | Comparative | Comparative | Comparative |
|---|---|---|---|---|---|---|---|
| | | Example 1 | Example 2 | Example 3 | Example 1 | Example 2 | Example 3 |
| Coating | Type of | Coating | Coating | Coating | Coating | — | — |
| solution | coating | solution 1 | solution 2 | solution 3 | solution 4 | | |
| | solution | | | | | | |
| | Type of | Binder | Binder | Binder | Binder | Binder | Binder |
| | binder | solution 1 | solution 1 | solution 2 | solution 3 | solution 1 | solution 4 |
| | solution | | | | | | |
| | Type of | Particle- | Particle- | Particle- | Particle- | Particle- | Particle- |
| | particle- | dispersed | dispersed | dispersed | dispersed | dispersed | dispersed |
| | dispersed | solution 1 | solution 2 | solution 1 | solution 1 | solution 3 | solution 4 |
| | solution | | | | | | |
| | Particle | 50 | 50 | 50 | 50 | 50 | 200 |
| | diameter d | | | | | | |
| | (nm) | | | | | | |
| | Particle | hollow | hollow | hollow | hollow | hollow | solid |
| | structure | | | | | | |
| | Particle | 5.0 | 4.0 | 5.0 | 5.0 | 5.0 | 5.0 |
| | concentration | | | | | | |
| | Cp (wt %) | | | | | | |
| | Binder | 1.2 | 1.2 | 2.4 | 4.8 | 4.8 | 4.8 |
| | concentration | | | | | | |
| | Cb (wt %) | | | | | | |
| | Cp/Cb | 4.2 | 3.3 | 2.1 | 1.0 | 1.0 | 1.0 |

TABLE 3

| | | | | Comparative | Comparative | Comparative |
|---|---|---|---|---|---|---|
| | Example 1 | Example 2 | Example 3 | Example 1 | Example 2 | Example 3 |
| Width L of | 38 | 43 | 72 | 200 | 143 | 118 |
| projections (nm) | | | | | | |
| Distance S | 101 | 98 | 89 | 20 | 134 | 256 |
| between | | | | | | |
| projections (nm) | | | | | | |
| L/S | 0.37 | 0.44 | 0.81 | 10.00 | 1.07 | 0.46 |

The following evaluations were performed for the optical members in Examples 1 to 3 and Comparative Examples 1 to 3. Table 4 shows the results.

### Evaluation of Adhesive Force

The adhesive force was measured with an AFM (E-Sweep manufactured by Seiko Instruments Inc.). A cantilever (force model AFM probe cantilever: FM, manufactured by sQUBE) on which a polystyrene particle having a diameter of 6.1 μm is mounted was attached to the AFM, and measurement was conducted. A point at which the cantilever contacted a sample was assumed to be zero, and a scanner to which the sample was attached was lifted up by 200 nm to press the cantilever against the sample. The adhesive force was determined from a force curve observed when the cantilever was detached from the sample. In each measurement, 20 points were measured and the average of the measured adhesive forces was defined as an adhesive force exerted between the sample and the polystyrene particle. The measurement was performed at 25° C. and a humidity of 45%.

The adhesive force was expressed as an adhesive force index, which was a relative value when the adhesive force of a fluorine-coated glass base serving as a standard sample was assumed to be 1.00.

As is clear from Table 4, the adhesive force indices in Examples 1 to 3 were lower than those in Comparative Examples 1 to 3.

### Evaluation of Haze

The hazes of the optical members in Examples 1 to 3 and Comparative Examples 1 to 3 were measured with a Haze Meter (NDH2000 manufactured by NIPPON DENSHOKU INDUSTRIES CO., LTD.). Table 4 shows the results of the hazes. The optical members produced in Examples 1 to 3 and Comparative Examples 1 and 2 each had a haze of less than 0.10 and thus caused only a low degree of scattering.

When the oblique incidence characteristics of light emitted from a light source at an angle of 450 with respect to the back surface of the base were checked, a small amount of fogging caused by scattering was observed in the optical members produced in Examples 1 to 3 and Comparative Examples 1 and 2. The degree of fogging in the optical member produced in Example 3 was lower than that in the optical members produced in Examples 1 and 2.

TABLE 4

| | | | | Comparative | Comparative | Comparative |
|---|---|---|---|---|---|---|
| | Example 1 | Example 2 | Example 3 | Example 1 | Example 2 | Example 3 |
| Adhesive | 0.07 | 0.08 | 0.13 | 0.83 | 1.10 | 4.30 |
| force index | | | | | | |
| Haze (%) | 0.09 | 0.09 | 0.08 | 0.08 | 0.08 | 1.50 |

### Evaluation of Surface Reflectance

The surface reflectances of the optical members in Examples 1 to 3 and Comparative Examples 1 to 3 and the standard sample used in the measurement of adhesive force were measured in a wavelength range of 450 nm to 650 nm in increments of 1 nm with a Lens Spectral Reflectivity Measurement Device (USPM-RU manufactured by Olympus Corporation).

The average reflectances of the optical members in Examples 1 to 3 and Comparative Examples 1 to 3 were lower than that of the standard sample by about 20% to 80%. In particular, the average reflectance of the optical member in Example 2 was lower than that of the standard sample by about 80%.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-136159, filed Jun. 28, 2013, which is hereby incorporated by reference herein in its entirety.

### REFERENCE SIGNS LIST

10 base
20 low-refractive-index layer
30 projection
40 particle
203 optical member

1. An optical member comprising:
a base; and
a low-refractive-index layer disposed on the base and comprising particles having a refractive index lower than that of the base,
wherein a plurality of projections are formed on a surface of the low-refractive-index layer,
a width of the projections is 5 nm or more and 80 nm or less, and
a distance between the projections is 80 nm or more and 250 nm or less.

2. The optical member according to claim 1, wherein a ratio of the width of the projections to the distance between the projections is less than 0.60.

3. The optical member according to claim 1, wherein the particles have a particle diameter of 10 nm or more and 100 nm or less.

4. The optical member according to claim 1, wherein the particles are hollow particles.

5. The optical member according to claim 1,
wherein the low-refractive-index layer comprises a binder for bonding the particles, and
a component ratio of the particles to the binder is more than 3.0.

6. The optical member according to claim 1, wherein the low-refractive-index layer has a thickness of 50 nm or more and 400 nm or less.

7. An image pickup apparatus comprising:
the optical member according to claim 1; and
an image pickup element.
